(19) United States
(12) Patent Application Publication
(10) Pub. No.: US 2021/0125073 A1
(43) Pub. Date: Apr. 29, 2021

(54) METHOD AND SYSTEM FOR INDIVIDUAL DEMAND FORECASTING

(71) Applicant: RUBIKLOUD TECHNOLOGIES INC., Toronto, CA (US)

(72) Inventors: Brian KENG, Toronto (CA); Tianle CHEN, North York (CA)

(21) Appl. No.: 16/662,336

(22) Filed: Oct. 24, 2019

(51) Int. Cl. G06N 3/08; G06N 20/00; G06F 17/18

(52) U.S. Cl. CPC G06N 3/084; G06F 17/18; G06N 20/00

(57) ABSTRACT

Provided is a system and method for individual forecasting of a future event for a subject using historical data. The historical data including a plurality of historical events associated with the subject. The method including: receiving the historical data associated with the subject; determining a random variable representing a remaining time until the future event; predicting a time to the future event using a distribution function that is determined using a recurrent neural network, the distribution function including a learned density with peaks that approximate the times of the historical events in the historical data; determining a log-likelihood function based on a probability that the random variable exceeds an amount of time remaining until a next historical event in the historical data and parameterized by the distribution function; and outputting a forecast of a time to the future event as the log-likelihood function.

### TECHNICAL FIELD

The following relates generally to data processing, and more specifically, to a method and system for individual demand forecasting.

### BACKGROUND

Accurately forecasting individual demand for acquisition of single items is a complex technical problem with many facets. It necessitates predicting not only the next most likely time of acquisition, but also having an accompanying measure of uncertainty is desirable due there likely being inherent randomness of in the acquisition, especially if it is based on an individual's behavior. Such forecasts often also coincide with sparse observations and partial information. Generally, sequential dependence is considered because future demand patterns can be heavily influenced by past behavior. Additionally, there may be strong correlation between demand patterns across substitutable acquisitions, generally requiring that acquisition behavior should be jointly predicted.

### SUMMARY

In an aspect, there is provided a method for individual forecasting of a future event for a subject using historical data, the historical data comprising a plurality of historical events associated with the subject, the method executed on at least one processing unit, the method comprising: receiving the historical data associated with the subject; determining a random variable representing a remaining time until the future event; predicting a time to the future event using a distribution function that is determined using a recurrent neural network, the distribution function comprising a learned density with peaks that approximate the times of the historical events in the historical data; determining a log-likelihood function based on a probability that the random variable exceeds an amount of time remaining until a next historical event in the historical data and parameterized by the distribution function; and outputting a forecast of a time to the future event as the log-likelihood function.

In a particular case of the method, a loss function for the recurrent neural network comprises a negative of the log-likelihood function.

In another case of the method, the random variable is conditioned based on inter-arrival times of the historical events in the historical data.

In yet another case of the method, the random variable is conditioned based on excess times since arrival of preceding historical events in the historical data.

In yet another case of the method, the log-likelihood function at each time is the log of the probability that the random variable is in the set of time until the next historical event when the next historical event has been observed, and the log of the survival function otherwise.

In yet another case of the method, the distribution function follows a Weibull distribution.

In yet another case of the method, the distribution function is determined as (k/λ)((s+t)/λ)^{k-1}S_{W}(t), where k is the shape of the Weibull distribution, λ is the scale of the Weibull distribution, t is the time-step, and S_{W}(t) is the survival function.

In yet another case of the method, outputting the forecast of the time to the future event as the log-likelihood function comprises determining a sum of log-likelihoods at each time-step.

In yet another case of the method, the method further comprising transforming the sum of log-likelihoods as a function of recurrent neural network parameters and historical data, and determining a minimizer of an overall observed loss of the recurrent neural network using such function.

In yet another case of the method, the method further comprising outputting derivative values of the log-likelihood function.

In another aspect, there is provided a system for individual forecasting of a future event for a subject using historical data, the historical data comprising a plurality of historical events associated with the subject, the system comprising one or more processors in communication with a data storage, the one or more processors configurable to execute: a data acquisition module to receive the historical data associated with the subject; a conditional excess module to determine a random variable representing a remaining time until the future event; a machine learning module 120 to predict a time to the future event using a distribution function that is determined using a recurrent neural network, the distribution function comprising a learned density with peaks that approximate the times of the historical events in the historical data; and a forecasting module to determine a log-likelihood function based on a probability that the random variable exceeds an amount of time remaining until a next historical event in the historical data and parameterized by the distribution function, and to output a forecast of a time to the future event as the log-likelihood function.

In a particular case of the system, a loss function for the recurrent neural network comprises a negative of the log-likelihood function.

In another case of the system, the random variable is conditioned based on inter-arrival times of the historical events in the historical data.

In yet another case of the system, the random variable is conditioned based on excess times since arrival of preceding historical events in the historical data.

In yet another case of the system, the log-likelihood function at each time is the log of the probability that the random variable is in the set of time until the next historical event when the next historical event has been observed, and the log of the survival function otherwise.

In yet another case of the system, the distribution function follows a Weibull distribution.

In yet another case of the system, the distribution function is determined as (k/λ)((s+t)/λ)^{k-1}S_{W}(t), where k is the shape of the Weibull distribution, λ is the scale of the Weibull distribution, t is the time-step, and S_{W}(t) is the survival function.

In yet another case of the system, outputting the forecast of the time to the future event as the log-likelihood function comprises determining a sum of log-likelihoods at each time-step.

In yet another case of the system, the forecasting module further transforms the sum of log-likelihoods as a function of recurrent neural network parameters and historical data, and determining a minimizer of an overall observed loss of the recurrent neural network using such function.

In yet another case of the system, the forecasting module further outputs derivative values of the log-likelihood function.

These and other embodiments are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for individual forecasting of a future event for a subject using historical data, in accordance with an embodiment;

FIG. 2 is a flowchart of a method for individual forecasting of a future event for a subject using historical data, in accordance with an embodiment;

FIG. 3 is a plot of an example of time-since-event (tse(t)) and time-to-event (tte(t)) until an end of a training period, in accordance with the system of FIG. 1;

FIG. 4A is an example of a distributional estimate for an uncensored case with time equals 3, in accordance with the system of FIG. 1;

FIG. 4B is an example of a distributional estimate for a censored case with time equals 7, in accordance with the system of FIG. 1;

FIG. 5 is a diagram of an example recurrent neural network (RNN) computational flow, in accordance with the system of FIG. 1;

FIG. 6 is a diagram of an example Bayesian Network, in accordance with the system of FIG. 1;

FIG. 7 is a chart of a receiver operating characteristic (ROC) curve for example experiments of the system of FIG. 1;

FIG. 8A illustrates a chart of predicted densities for remaining useful life (RUL) for the example experiments of FIG. 7;

FIG. 8B illustrates a chart of predicted modes for RUL for the example experiments of FIG. 7;

FIG. 9A illustrates a histogram of errors for a comparison approach in the example experiments of FIG. 7; and

FIG. 9B illustrates a histogram of errors for the system of FIG. 1 in the example experiments of FIG. 7.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to data processing, and more specifically, to a method and system for individual demand forecasting.

For the sake of clarity of illustration, the following disclosure generally refers to the implementation of the present embodiments for product demand forecasting; however, it is appreciated that the embodiments described herein can be used for any suitable application of individual event forecasting. For example, the embodiments described herein could be used to predict the time until a future occurrence of a natural event; such as an earthquake as the subject to be forecasted. In another example, the embodiments described herein could be used to predict the time until a utility spike occurs; such as a spike in electricity consumption or a spike in internet bandwidth as the subjects. In another example, the embodiments described herein could be used to predict component failure times for factory machinery; such as using workload history as input. In another example, the embodiments described herein could be used to predict various other consumer behavior patterns; such as predicting when a client will go on vacation.

In an illustrative example, retailers can have access to massive amounts of consumer behavior data through, for example, customer loyalty programs, purchase histories, and responses to direct marketing campaigns. These data sources can allow retailers to customize their marketing communications at the individual level through personalized content, promotions, and recommendations via channels such as email, mobile and direct mail. Accurately predicting every individual customer behavior for each product is useful in direct marketing efforts which can lead to significant advantages for a retailer driving increased sales, margin, and return on investment. Especially for replenishable products such as regularly consumed food products (e.g. milk) and regularly replenished personal care products (e.g. soap). These products frequently drive store traffic, basket size, and customer loyalty, which are of strategic importance in a highly competitive retail environment.

In the above illustrative example, accurately forecasting individual demand for single products is a challenging and complex technical problem. This problem generally requires predicting not only the next most likely time of purchase of the product but also having an accompanying measure of uncertainty due to the inherent randomness of an individual's purchasing behavior. Additionally, this problem usually has sparse observations (for example, few observations for individual customers) and partial information (for example, purchases of related products and time since last purchase). Additionally, this problem usually has sequential dependence because future purchase patterns are generally heavily influenced by past behavior. Additionally, this problem usually has strong correlation between purchase patterns across substitutable products that indicates that customer behavior should be jointly predicted. For example, among purchasers of items in a basket of 12 deli products that were recorded, there were 79,980 unique purchasers. Purchase histories for any single product is generally sparse. For any single product in this basket, the average customer buys only between 0.12 to 0.67 items over a 1.5-year period but aggregating over all the products in the basket indicates that these customers purchase on average 3.58 items during the same period. This is not surprising since people tend to prefer variety in their meals even though their choice of whether to purchase a deli product can in some cases be predicted.

Some approaches for accurately forecasting individual demand for single products adapt methods from survival analysis, where a customer is defined to be “alive” if purchases were made. In a scenario with sparse purchase data, this can be useful since non-purchases can reveal information about whether a customer is likely to make a purchase in the future. In addition to modeling whether customers are “alive”, the number of purchases a customer makes in a given time period can also be accounted for. Solving this maximum likelihood problem can yield optimal distributional estimates that model such behaviors. However, these models impose strict assumptions that limit their effectiveness; such as independence and stationarity. In addition, covariates are often modeled in a regression context, further restricting the hypothesis space. While these assumptions may be essential for tractability purposes, in some cases, they can be easily violated when there is a desire to model highly-correlated, high-dimensional and heterogeneous processes. One example of a survival model is a Pareto/NBD model. In this model, heterogeneity of customer purchase rates and customer dropout times are assumed to follow parametric distributions. While this may be suited for predicting a time-to-event, incorporating covariates in this context generally requires imposing a linearity assumption on one of the model parameters in order to fit a model; which is an unrealistic assumption for models with a large number of data features. While copulas may be used to model customer repurchase patterns, they cannot be sufficiently extended to predict multiple products jointly and under changing environmental conditions.

Some approaches for accurately forecasting individual demand for single products attempt to use machine learning approaches to predict arrival times; for example, Recurrent Neural Networks (RNNs). These approaches leverage the capacity of RNNs to model sequential data with complex temporal correlations as well as non-linear associations. However, these models generally do not deal explicitly with the uncertainty of random arrival times and are not able to properly exploit censored data. Other machine learning approaches have been used; for example, Random Forest models and other ensemble models have been used with binary predictions due to their scalability to wide datasets, ease of training and regularization strategies. However, such tree-based supervised learning models are not well suited to sequentially dependent problems. Recurrent Neural Nets (RNN) are better suited to model data with complex sequential dependencies. For example, using a Long-Short-Term-Memory (LSTM) structure that incorporates gates to recursively update an internal state in order to make sequential path-dependent predictions. In an example LSTM can be trained to make point estimates for time-to-event by minimizing a distance-based metric. However, unobserved arrival times cannot be explicitly accounted for in these models. Non-arrivals can be important as they can reveal a significant amount of information for the prediction.

Embodiments of the present disclosure advantageously integrate probabilistic approaches of survival analysis with Recurrent Neural Networks to model inter-purchase times for multiple products jointly for each individual customer. In some embodiments, the output of the RNN models the distribution parameters of a “time to next purchase” random variable instead of a point estimate. In a survival analysis framework, partial information, such as time since the previous arrival, can induce a distribution on the partially observed version of the “time to next purchase” random variable. The structure of such embodiments can impose additional constraints which transform the complex censoring problem into a likelihood-maximization problem. Advantageously, the use of RNNs can remove the need for strict assumptions of past survival analysis models while still having the flexibility to take into account the censored and sequential nature of the problem. In the present disclosure, such Multivariate Arrival Times Recurrent Neural Network models may be referred to as “MAT-RNN”.

The present inventors determined the efficacy of the present embodiments in example experiments. The example experiments were performed on data from a large European health and beauty retailer, several benchmark datasets as well as a synthetic dataset. The present embodiments were determined to out-perform other approaches in predicting whether a customer made purchases in the next time period. The results of the example experiments illustrate that the present embodiments perform better than other approaches in 4 out of the 5 categories of products considered. Additionally, results on the benchmark and synthetic datasets show comparable performance increases when compared to other survival model techniques and RNNs trained on the usual squared-loss metric.

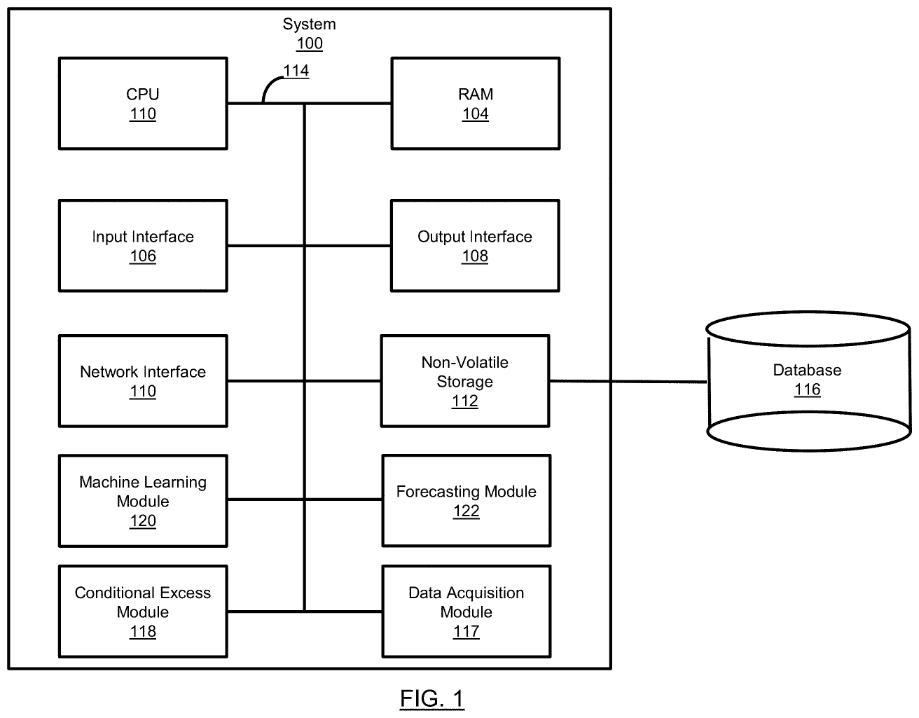

Referring now to FIG. 1, a system 100 for individual forecasting of a future event for a subject, in accordance with an embodiment, is shown. In this embodiment, the system 100 is run on a server. In further embodiments, the system 100 can be run on any other computing device; for example, a desktop computer, a laptop computer, a smartphone, a tablet computer, a point-of-sale (“PoS”) device, a smartwatch, or the like.

In some embodiments, the components of the system 100 are stored by and executed on a single computer system. In other embodiments, the components of the system 100 are distributed among two or more computer systems that may be locally or globally distributed.

FIG. 1 shows various physical and logical components of an embodiment of the system 100. As shown, the system 100 has a number of physical and logical components, including a central processing unit (“CPU”) 102 (comprising one or more processors), random access memory (“RAM”) 104, an input interface 106, an output interface 108, a network interface 110, non-volatile storage 112, and a local bus 114 enabling CPU 102 to communicate with the other components. CPU 102 executes an operating system, and various modules, as described below in greater detail. RAM 104 provides relatively responsive volatile storage to CPU 102. The input interface 106 enables an administrator or user to provide input via an input device, for example a keyboard and mouse. The output interface 108 outputs information to output devices, such as a display and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution.

In an embodiment, the system 100 further includes a data acquisition module 117, a conditional excess module 118, a machine learning module 120, and a forecasting module 122. In some cases, the modules 117, 118, 120, 122 can be executed on the CPU 110. In further cases, some of the functions of the modules 117, 118, 120, 122 can be executed on a server, on cloud computing resources, or other devices. In some cases, some or all of the functions of any of the modules 117, 118, 120, 122 can be run on other modules.

Forecasting is the process of obtaining a future value for a subject using historical data. Machine learning techniques, as described herein, can use the historical data in order to train their models and thus produce reasonably accurate forecasts when queried.

In some embodiments, the machine learning module 120 uses a Recurrent Neural Net (RNN) to output distributional parameters which represent predictions for the remaining time to arrival. By iterating through time for each customer, the RNN can output sequential distributional estimates for the remaining time until the next purchase arrival, giving an individual demand forecast. Advantageously, the output as a distribution can allow for better decision-making ability because it can allow for the performance of a cost analysis.

In some cases, each product's inter-purchase time can be assumed to be a realization of a random variable that is distinct for each customer and each product. In some cases, each product's inter-purchase time can also be dependent on other product purchase times. The conditional excess module 118 can use a conditional excess random variable, which represents a remaining time till next arrival conditioned on observed information to date. This random variable can have a distribution that is induced by an actual inter-purchase time as well as a censoring state.

In some embodiments, the forecasting module 122 can determine a log-likelihood function based on the conditional excess random variable and the outputs of the RNN. In some cases, it is assumed that the approach of these embodiments follows a conditional independence structure where these conditional excess random variables are assumed to be independent given the internal state of the RNN. In such embodiments, the loss function can be defined to be the negative log-likelihood. The optimal RNN parameters in such embodiments can generate distributional parameters that can be advantageously used to model the observed data. Hence, the RNN outputs at the end of training period can be used by the forecasting module 122 as best distributional estimates for a remaining time to next purchase.

In the present disclosure, a random variable representing the remaining time till next arrival conditioned on the current information is denoted as Zₜ. In most cases, this random variable is not the true inter-arrival time, but is instead a version of it, conditioned on observing partial information. Consider an arrival process, where Wₙ is the time of the n-th arrival. Let W₀=0 at the start of a training period. Additionally, let N(t) be the number of arrivals by time t and let Yₙ be the inter-arrival time of the n-th arrival, which is the difference between consecutive arrival times.

N(t)=max{n|Wₙ≤t}

Yₙ=Wₙ−Wₙ₋₁ (1)

At a particular time t, the number of arrivals observed is N(t). The system 100 predicts the subsequent (i.e. the {N(t)+1}-th arrival) and its inter-arrival time Y_{N(t)+1}. Let tse(t) (time-since-event) be the amount of time that has elapsed since the last arrival or start of training period, whichever is smaller. This represents the censoring information that is available to the RNN at each time t. Let tte(t) (time-to-event) be the amount of time remaining until the next arrival or the end of testing period (τ), whichever is smaller.

tse(t)=t−W_{N(t)}

tte(t)=min{W_{N(t)+1}−t, τ−t} (2)

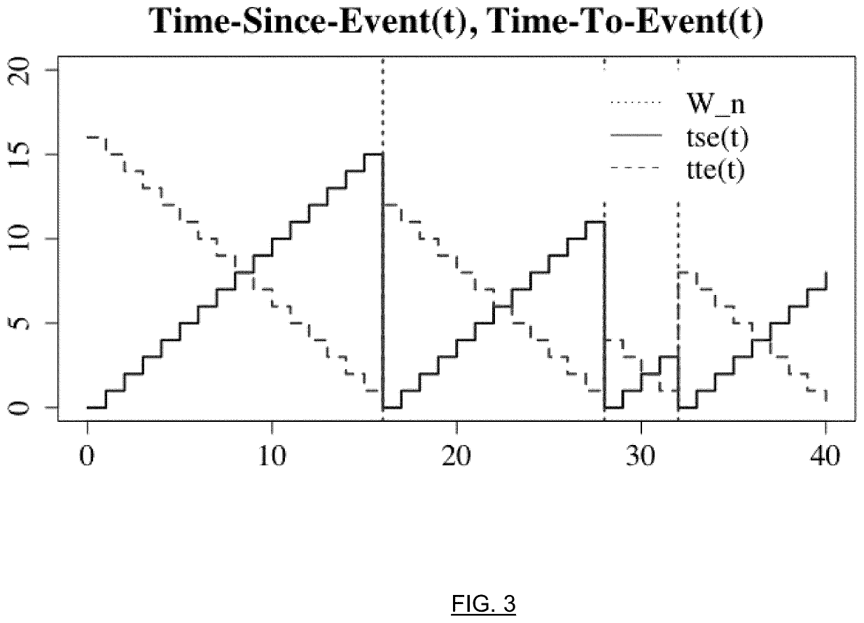

For the purposes of illustration, consider an example of the above with 3 arrivals; where W₁=16, W₂=28, and W₃=32, such that Y₁=16, Y₂=12, and Y₃=4. Also, N(t) is a piecewise constant function which is 0 for t<16, 1 for t∈[16, 28), 2 for t∈[28, 32), and 3 for t≥32. FIG. 3 illustrates an example plot of tse(t), tte(t) for t until τ=40, which is the end of the training period.

In some embodiments, the remaining time till next arrival (Zₜ) can be a conditional random variable that depends only on Y_{N(t)+1}, which is the inter-arrival time of the subsequent arrival. The random variable Zₜ, given the observed information, can thus be defined; which is referred to as a conditional excess random variable. In these embodiments, Zₜ has a distribution induced by Y_{N(t)+1} since tse(t) is fixed.

Zₜ=Y_{N(t)+1}−tse(t)|Y_{N(t)+1}>tse(t). (3)

For example, consider Z=Y−t|Y>t. This random variable Z is conditioned on the fact that Y has been observed to exceed t and the system 100 is interested in the excess value; i.e., Y−t. The distribution of Y induces a distribution on Z.

$$P ( Z > s ) = P ( Y - t > s \vert Y > t ) = \frac{P ( Y > s + t )}{P ( Y > t )} \qquad ( 4 )$$

In an embodiment, there are two cases to define the log-likelihood function. When the next arrival time is observed, the likelihood evaluation is P (Zₜ∈[tte(t), tte(t)+1]), since inter-arrival times are only discretely observed. However, where the time to next arrival is not observed (i.e. no more subsequent arrivals are observed by end of training), the likelihood evaluation is instead P (Zₜ>tte(t)), namely the survival function. Therefore, at each time t, the random variable Y_{N(t)+1} which has distribution parametrized by θₜ, induces a distribution on Zₜ. Thus, the log-likelihood at each time t can be written as follows:

$${l}_{t} ( {θ}_{t} ) = \{ \begin{matrix}log P ( {Z}_{t} ∈ [ t t e ( t ) , t t e ( t ) + 1 ] ) & if uncensored \\ log P ( {Z}_{t} > tte ( t ) ) & otherwise\end{matrix} \qquad ( 5 )$$

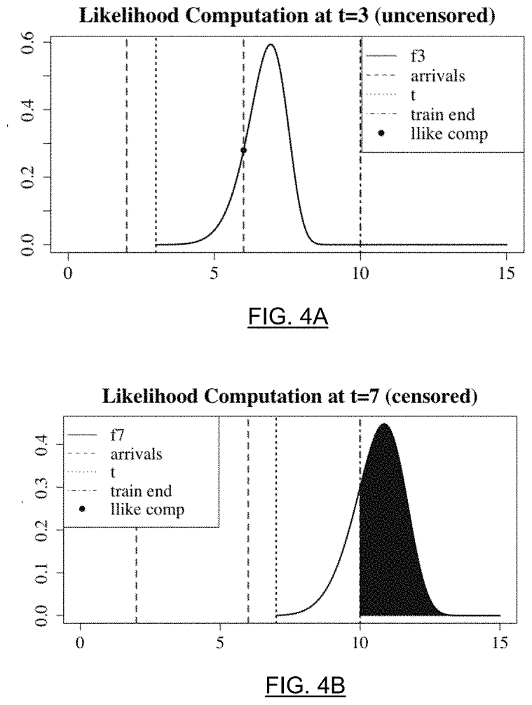

FIGS. 4A and 4B illustrate examples of distributional estimates at two respective times (t=3 for FIG. 4A and t=7 for FIG. 4B) to illustrate the above two cases. FIGS. 4A and 4B illustrate log-likelihood visualizations for different censoring statuses. In the uncensored log-likelihood computation, f3 is a density function of Z₃, which is the predictive distribution for the remaining time till next arrival. Since the next arrival is observed to have occurred at time 6, f3 is evaluated at the value 3, which is the true time to next arrival to compute the log-likelihood. In the censored case, for the predictive distribution at time 7, the next arrival was not observed and hence the right tail of Z₇ (i.e. ≥3) was used to compute the log-likelihood.

It can be generally assumed that Yₙ follows distributions with differentiable density and survival functions to exploit the back-propagation approach used to fit the RNN. An example is a Weibull distribution parametrized by scale (λ) and shape (k), whose survival function is made up of exp() and power() functions.

S(y)=P(Y>y)=e ^{-(y/λ)}^{^{k}} (6)

To determine Weibull likelihoods, a random variable Y˜Weibull (scale=λ, shape=k) can be determined that has simple densities and cumulative distribution functions. Since the survival function (S(x)) has the form:

$$\begin{matrix}S ( y ) = P ( Y > y ) \\ = {e}^{- {( y / λ )}^{k}} \\ f ( y ) = ( k / λ ) {( y / λ )}^{k - 1} {e}^{- {( y / λ )}^{k}} \\ = ( k / λ ) {( y / λ )}^{k - 1} S ( y )\end{matrix}$$

The conditional excess random variable, given that it exceeds s, is W=Y−s|Y>s. The definition of conditional probability in terms of some continuous random variable X₁, X₂, for any measurable set A₁, A₂, given P (X₂∈A₂)>0:

$$P ( {X}_{1} ∈ {A}_{1} \vert {X}_{2} ∈ {A}_{2} ) = \frac{P ( {X}_{1} ∈ {A}_{1} , {X}_{2} ∈ {A}_{2} )}{P ( {X}_{2} ∈ {A}_{2} )}$$

The conditional excess survival function can thus be derived as:

$$\begin{matrix}{S}_{w} ( t ) = P ( W > t ) \\ = P ( Y > s + t \vert Y > s ) \\ = S ( s + t ) / S ( s ) \\ = exp \{ - {( ( s + t ) / λ )}^{k} + {( s / λ )}^{k} \}\end{matrix}$$

The conditional excess density function can be determined as:

$$\begin{matrix}{f}_{W} ( t ) = f ( s + t ) / S ( s ) \\ = ( k / λ ) {( ( s + t ) / λ )}^{k - 1} S ( s + t ) / S ( s ) \\ = ( k / λ ) {( ( s + t ) / λ )}^{k - 1} {S}_{W} ( t )\end{matrix}$$

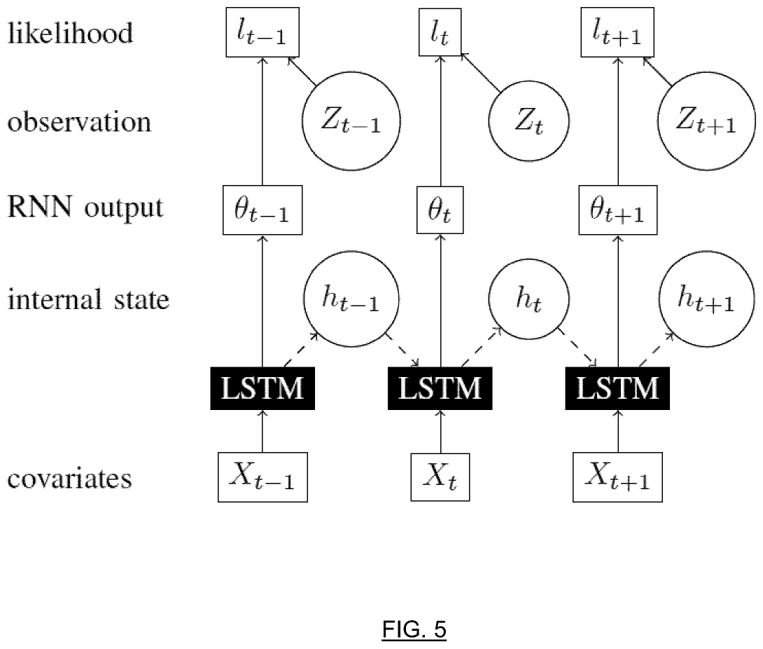

In an example, a Long Short Term Memory (LSTM) model can be used by the machine learning module 120 as a type of RNN structure for modeling sequential data. In further cases, other types of RNN models can be used by the machine learning module 120. At each time (t), the outputs of the LSTM, which is parametrized by θ, are passed through an activation function so that they are valid parameters of a distribution function (θₜ). Then, the log-likelihood is determined for each time step (lₜ) by the forecasting module 122, as described herein. FIG. 5 illustrates an example RNN computational flow with outputs (et) generated by the LSTM. Log-likelihoods at each time are determined as log of densities parametrized by θt, evaluated at zt. Where hₜ is the internal state of the LSTM and Xₜ are the covariates at each time t. In this way, the machine learning module 120 can output a single prediction of expected value for each time (t).

In some embodiments, the machine learning module 120 can determine loss as a negative of the log-likelihood. Optimal parameters for the LSTM (θ) can be determined as outputs of a series of distributional estimates θₜ that best “explain” the sequence of data observed. In a particular case, the distribution can be a normal distribution. In the event of an uncensored arrival time at time t, the weights θₜ can be determined as those that generate a density that has a peak close to the actual arrival time. In this way, at each time step, a range of values and their relatively likelihood are provided; with the output denoted by θₜ. Advantageously, with an output as a distribution, additional operations can be performed. For example, determining a “best guess” expected value of the distribution. For example, certain quantities of the distribution can also be optimized; for example, it might be more costly to under-predicted to over-predict, producing a different “best guess.” For example, a credibility interval can be used (for example, a 90% credible interval) to determine where an output value is most likely to be; which can allow for better planning and better decision making.

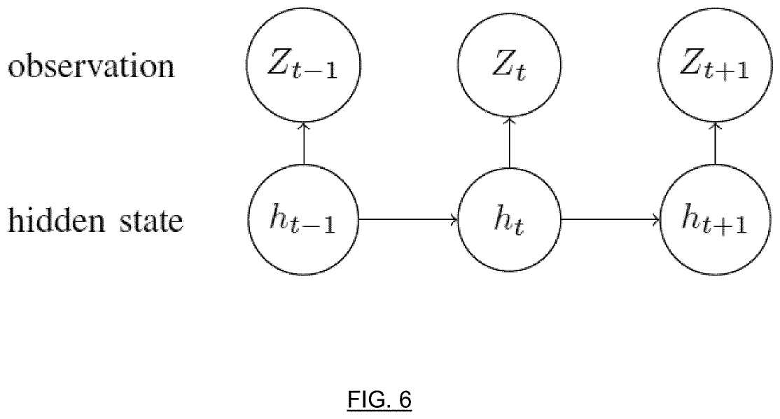

In an embodiment, the machine learning module 120 can assume a Bayesian Network, for example similar to a Hidden-Markov model, where random variables at each time t are emitted from a hidden state hₜ. As described, hₜ represents an internal state of the RNN at each time t and Zₜ is an observed time series. FIG. 6 illustrates an example of a Bayesian Network where observations are independent conditioned on hidden states.

The forecasting module 122 can factor the joint distribution of {Zₜ}, giving the log-likelihood for an entire time series as a sum of log-likelihoods at each time; such that the forecasting module 122 obtains a sum described below, for arbitrary events Eₜ. Since Eₜ is determined by the censoring status, where Eₜ={[tte(t), tte(t)+1]} if uncensored and Eₜ={>tte(t)} otherwise, the forecasting module 122 can decompose the overall log-likelihood as a sum:

$$P ( {\{ {Z}_{t} ∈ {E}_{t} \}}_{t = 1}^{τ} \vert {\{ {h}_{t} \}}_{t = 1}^{τ} ) = {\prod }_{t = 1}^{τ} P ( {Z}_{t} ∈ {E}_{t} \vert {h}_{t} ) \\ l ( \{ {θ}_{t} \} ) = {\sum }_{t} {l}_{t} ( {θ}_{t} ) \qquad ( 7 )$$

Assuming that the RNN model is parametrized by e, there exists a function g that recursively maps Xₜ to (θₜ, hₜ) that depends only on θ. By substituting hₜ₋₁, lₜ(θₜ)=lₜ(gₜ(θ)) where gₜ depends only on θ, g, {Xₗ}}_{l≤t}. Then since the overall log-likelihood is a sum of lₜ(θₜ), it can be written as a function of only the RNN parameters (θ) and observed data. The structure of the RNN and the back-propagation algorithm allows the determination of gradients of any order efficiently and therefore allows for the determination of \hat{Θ}, the minimizer of the overall observed loss.

(θₜ, hₜ)=g(hₜ₋₁, Xₜ|θ) (8)

In some embodiments, the machine learning module 120 can transform the outputs of the RNN such that they are parameters of a distribution. In a particular case, the machine learning module 120 can use a Weibull distribution, which is parametrized by shape and scale parameters, both of which are positive values. In example cases, the RNN output can be initialized for scale at the maximum-likelihood estimate (MLE) for a scale parameter of a Weibull distribution whose shape parameter is 1; as this was determined by the present inventors to be useful in preventing likelihood-evaluation errors. In example cases, a maximum shape parameter (set at 10) can be used and the RNN output can be passed for shape through a sigmoid function, which is rescaled and shifted such that σ*: [symbol] →(0, 10) and σ*(0)=1. In some cases, for the scale parameter, an exponential function is used, which is rescaled such that it maps 0 to the average inter-arrival-time.

In some embodiments, the system 100 can model multivariate arrivals by assuming there are p different arrival processes of interest. For the i-th waiting time of interest, W_{i,n} is defined to be the time of the n-th arrival of this type and Nᵢ(t), and Y_{i,n} is likewise defined. Additionally, tse(i, t) and tte(i, t) are defined for the i-th type.

Z_{i,t}=Y_{i,N(t)+1}−tse(i, t)|Y_{i,N(t)+1}>tse(i,t) (9)

Using the example of the Bayesian Network of FIG. 6, Zₜ=[Z_{1,t}, . . . , Z_{p,t}] and the RNN output θₜ=[θ_{1,t}, . . . , θ_{p,t}]. The log-likelihoods for each event type can be determined where l_{i,t}(θ_{i,t})=log P(Z_{i,t}=tte(i, t)) or l_{i,t}(θ_{i,t})=log P (Z_{i,t}>tte(i, t)), recalling that the former is for the case where the next arrival is observed while the latter is for the case where the no arrivals are observed until the end of training.

Advantageously, the Bayesian Network of FIG. 6 generally requires minimal modifications as it merely requires that the emissions are conditionally independent given hₜ. The forecasting module 122 can then determine the log-likelihood at each time as a sum, lₜ(θₜ)=Σᵢ l_{i,t}(θ_{i,t}). Since the LSTM model is still parameterized by e, the remaining operations are the same as described above. In this way, temporal dependence as well as dependence between the p arrival processes can be modeled by the RNN, whose weights θ can then be optimized by training data. This allows the forecasting module 122 to also model other outputs by appending [K_{1,t}, . . . , K_{p,t}] to Zₜ where K_{j,t} is some other variable of interest for process j at time t. In the retail product forecasting example, K_{j,t} can be other factors affecting the customer; for example, a promotion. In a factory machinery example, K_{j,t} can be other variables that affect output; for example, ambient temperature

In some cases, for multi-variate purchase arrival times, masking sequences observed before the first arrival of each product can be useful in preventing numerical errors encountered in stochastic gradient descent. In these cases, log-likelihoods determined for time steps before the earliest arrival can be masked. In the case of RNNs, each time step can have a component in the loss function (for each output) and masking can be used to remove those time steps from the loss function so that they are not used in the optimization. This can ensure that RNN parameters are not updated due to losses incurred during these times.

The forecasting module 122 can determine predictions using the fact that at each time t, the estimated parameter θₜ can be used to determine the expectation of any function of Zₜ; assuming that Zₜ is distributed according to θₜ. Since the system 100 takes into account the next arrival time after the end of training period (time τ), it can compute many different values of interest. As described herein, the values of interest can be derivative values of the output distribution; for example, expected value, median, 90% credible range, some other cost function (using a different under/over weighting of forecasts), and the like.

For example, the forecasting module 122 can determine a predicted probability that the next arrival will occur within y time after end of training, and thus determine P (Z_{τ}≤γ). The forecasting module 122 can also determine a deferred arrival probability, which is the probability that the next arrival will occur within an interval of between γ₁ and γ₁+γ₂ time after end of training; given that the forecasting module 122 knows it will not occur within γ₁ time after the end of training. This can be determined by computing P (Z_{τ}∈E [γ₁, γ₁+γ₂]|Z_{τ}>γ₁). The quantities of interest may not necessarily be limited to probabilities (for example, mean and quantiles of the predictive distribution) and can be extended to generate other analytics; for example, in the case of predicting product purchases, to aid in revenue analysis or forecasting that depends on the subsequent purchase time.

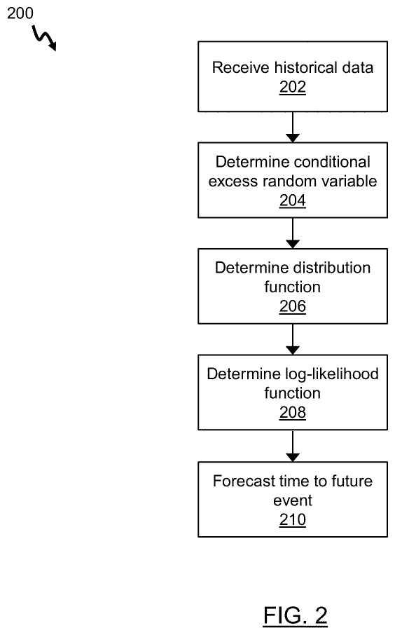

Turning to FIG. 2, a flowchart for a method 200 for individual forecasting of a future event for a subject, according to an embodiment, is shown. The forecast is based on historical data, for example, as stored in the database 116 or as otherwise received. The historical data comprising a plurality of historical events associated with the subject.

At block 202, the data acquisition module 117 receives the historical data associated with the subject from the input interface 106, the network interface 110, or the non-volatile storage 112. At block 204, the conditional excess module 118 determines a random variable representing a remaining time until the future event. The random variable conditioned based on excess times since arrival of the historical events in the historical data.

At block 206, the machine learning module 120 determines a distribution function that predicts the time of the future event using a recurrent neural network. The distribution function comprising a learned density with peaks that approximate the times of the historical events in the historical data.

At block 208, the forecasting module 122 determines a log-likelihood function based on a probability that the random variable exceeds an amount of time remaining until a next historical event in the historical data and parameterized by the distribution function. A loss function for the recurrent neural network comprising a negative of the log-likelihood function.

At block 210, the forecasting module 122 forecasts and outputs a time to the future event for a given subject using the log-likelihood function.

Described below are three sets of example experiments conducted by the present inventors to verify the functionality, efficacy, and advantages of the present embodiments. First, example experiments were conducted to check model assumptions and verify that parameters for Weibull inter-arrival times can be recovered by the present embodiments (using MAT-RNN) on a synthetic dataset. Second, example experiments were performed to compare the performance of MAT-RNN on two open datasets to benchmark models. Third, example experiments were conducted to apply MAT-RNN to predict customer purchases for a large retailer and compare its performance to other approaches in the art.

For the example experiments, a structure used for the RNN had three stacked layers, with two LSTM layers of size W followed by a densely connected layer of size 2p, where p is the number of arrival processes. The densely connected layer transforms the LSTM outputs to a vector of length 2p. In MAT-RNN, the densely connected layer outputs are passed through an activation layer. For squared-loss RNNs, the activation can be passed through a softplus layer since time to arrivals are non-negative.

In the example experiments, a masking layer was applied prior to the other layers so that the RNN does not train on time indices prior to the initialization of the time series. This structure is the same for other neural network based models used for benchmark comparison. The RNN was trained with a learning rate of 0.001 and trained for 100 steps unless otherwise stated. Gradients were component-wise clipped at 5 to prevent numerical issues.

The example experiments used a generated synthetic dataset, where inter-arrival times followed Weibull distributions. In the synthetic dataset, as shown in TABLE 1, a set of Weibull parameters was generated for each of eight product types, from which inter-arrival times are sampled. The individual product identification is referred to as SKU (stock keeping unit).

TABLE 1

| SKU | 0 | 1 | 2 | 3 | 4 | 5 | 6 | 7 |
|---|---|---|---|---|---|---|---|---|
| Shape | 42.48 | 32.35 | 37.68 | 1.99 | 26.59 | 6.91 | 20.57 | 8.04 |
| Scale | 1.15 | 1.09 | 1.06 | 1.01 | 0.97 | 0.88 | 0.62 | 0.78 |

Purchase times were recorded and used to train the MAT-RNN model. In the example experiments, there were 11,000 subjects. Event arrivals were observed over a period of 156 time steps. It was then verified that the trained model (W=6) recovers these parameters by taking the RNN predictions at the last time step. The results indicated that relative error (i.e. \hat{θ}−θ, where \hat{θ} is the estimated parameter and θ is the true parameter) is low for both scales as well as shapes. TABLE 2 shows errors for estimated parameters for Weibull inter-arrival.

TABLE 2

| | Mean | Quantiles (×10⁻²) | | | | |
|---|---|---|---|---|---|---|
| Parameter | (×10⁻²) | 0 | 25 | 50 | 75 | 100 |
| Shape | +1.02 | −1.21 | −0.10 | +0.58 | +1.02 | +4.82 |
| Scale | +2.32 | −3.55 | −0.61 | +0.61 | +5.25 | +11.80 |

The example experiments show the flexibility of the present embodiments with two open dataset benchmarks. Generally, these two problems are often tackled with different models since the prediction problem is different. The model of the present embodiments can, however, be adapted to solve these problems since they can be modeled by a distributional approach to inter-arrival times.

The first example dataset is the CDNOW dataset. For this dataset, the example experiments considered a binary classification problem where the system 100 predicts if purchases are made during a testing period. Predictions by the system 100 were determined as the probability that the inter-arrival time occurs before end of testing period. The input data was the transaction history where only purchase records are available without other covariate data. The example experiments show that present embodiments out-perform other approaches on this dataset, even with no covariates.

The second example dataset is based on the CMAPSS dataset. For this dataset, the system 100 predicted the remaining useful lifetime, or the time to failure. Predictions were determined as the mode, mean, or some other function of the inter-arrival time distribution. The training data was an uncensored time series where sensor readings and operational settings were collected up until the engine fails. A customized loss function was used to evaluate models.

The CDNOW dataset includes purchase transactions, where number of customer purchases are recorded. Transaction dates, purchase counts, and transaction values were available as covariates. The performance of the present embodiments, where W=1 trained on a weekly level, was compared to another approach, the Pareto/NBD model, which is a classical demand forecasting model using the lifetimes package. The CDNOW dataset is often used as an example where Pareto/NBD type models do well since there's limited covariate data available and there is only a single event type.

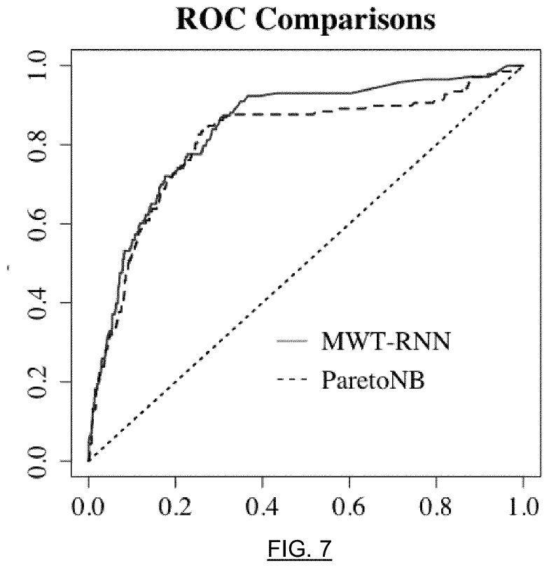

In the example experiments, with W=1, there were 32 trainable parameters in the MAT-RNN model of the present embodiments. The training period was set at 1.5 years, from 1997 Jan. 01 to 1998 May 31. Predictions were made for customer purchases within a month of the end of training; i.e., before 1998 Jun. 30. As illustrated in the chart of FIG. 7, the MAT-RNN model of the present embodiments achieved an ROC-AUC (area under the receiver operating characteristic curve) of 0.84 on the CDNOW dataset; which is substantially better when compared to 0.80 that is obtained using the Pareto/NBD estimate for the “alive” probability. It can be seen that the approach of the present embodiments of integrating a survival-based maximum log-likelihood approach with an RNN yielded substantially improved prediction accuracy, even with a small number of weights and on a small dataset.

The CMAPSS dataset is a high dimensional dataset on engine performance with 26 sensor measurements and operational settings. In training of the model for the example experiments, the engines were run until failure. In testing of the model, data was recorded until a time prior to failure. The goal was to predict the remaining useful life (RUL) for these engines. A first set of engine simulations in the dataset, which has 100 uncensored time series of engines, were run until failure. The maximum cycles run before failure was found to be 363. Time series for each engine was segmented into sliding windows of window length 78, resulting in 323 windowed time series each of length 78. For the testing dataset, the RNN model was run on a time series 78 cycles before end of observation. A custom loss function was used, where over-estimation was more heavily penalized. The mean custom loss metric (MCL) is defined as follows, where d is the predicted RUL subtracted by the true RUL:

$$loss ( d ) = \{ \begin{matrix}{e}^{- d / 13} - 1 & d < 0 \\ {e}^{d / 10} - 1 & d > 0\end{matrix} \qquad ( 10 )$$

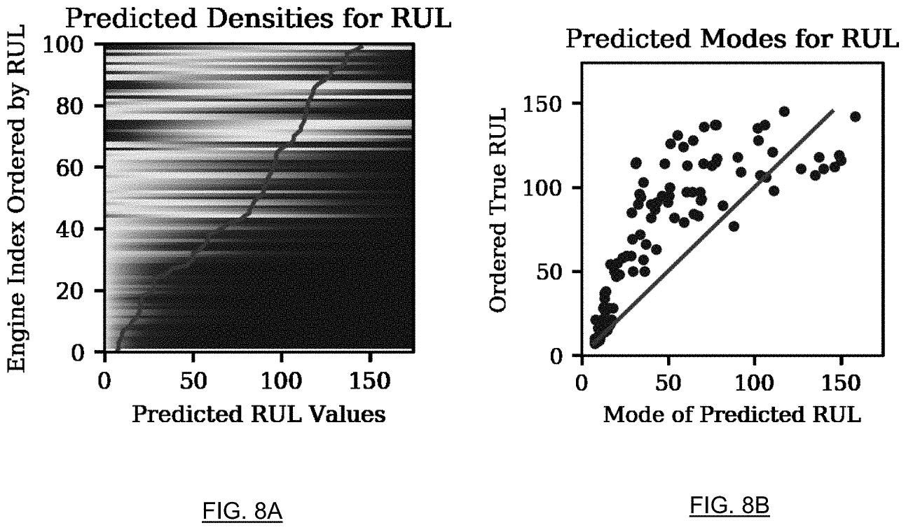

The performance of the MAT-RNN model of the present embodiments was compared to the SQ-LOSS, which has a softplus activation and is trained on squared loss. Performance was evaluated based on the mean squared loss metric (MSE) as well as the MCL. The RNN models were trained with W=64. As illustrated in FIGS. 8A and 8B, the performance of MAT-RNN was substantial, with modes that correspond roughly to the true RUL. FIG. 8A illustrates a chart of predicted densities for RUL on C-MAPSS and True RUL. FIG. 8B illustrates a chart of predicted modes for RUL on C-MAPSS and True RUL.

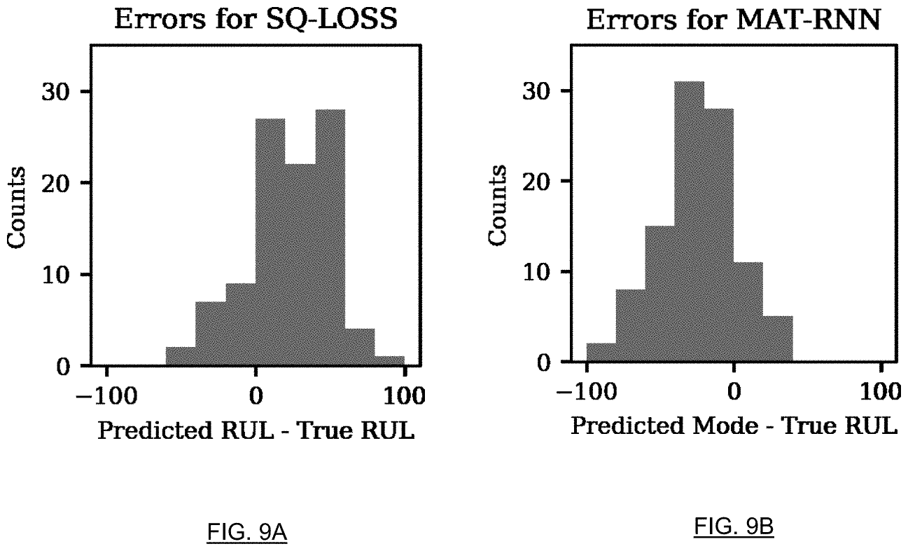

The example experiments determined that the MAT-RNN model of the present embodiments performed better than SQ-LOSS in the metrics considered, with MAT-RNN having a mean loss of 40.09 compared to SQ-LOSS of 193.36. In the RMSE metric (root-mean-squared-error), MAT-RNN had an error of 35.65 compared to SQ-LOSS which as 36.48. It was advantageously determined by the present inventors that MAT-RNN is more biased towards under-estimating RUL which makes it perform much better in the custom loss metric. Also, we find that from the histogram of errors illustrated in FIGS. 9A and 9B that MAT-RNN predictions are unimodal and clustered tightly around its mode. FIG. 9A illustrates a histogram of errors for SQ-LOSS and FIG. 9B illustrates a histogram of errors for MAT-RNN.

In the example experiments, the present inventors determined the predictive performance on a real-life application for predicting purchases of a few baskets of goods sold by a large European retailer. The time resolution of the dataset was on a weekly level. Training data was available over roughly 1.5 years, which gave 78 weeks of training data from 2014 Jan. 01 to 2015 Jun. 30. Performance of the MAT-RNN model of the present embodiments was measured on a binary classification problem of predicting whether a customer purchases the product within 4 weeks after the end of training period from 2015 Jun. 30 to 2015 Jul. 31.

The MAT-RNN model of the present embodiments can be used to predict various different quantities of interest; however, for the purposes of the example experiments, comparison was of the predictive performance of the MAT-RNN model to a few benchmark models. Such comparison was with respect to whether an event will arrive within y time after the end of the training period. The benchmark models were a Squared-Loss RNN (SQ-RNN) and a Random Forest Predictor (RNG-F). Models were trained on all customers who bought an item in the basket during the training period and performance was evaluated on this group of customers during the testing period.

RNG-F was trained by splitting the training period into two periods. Covariates at the end of the first period were fed into the model, which was trained to predict whether subjects purchase in the second period, which was also y long. A different RNG-F model was trained for each product, but was fed covariate datasets for all products.

SQ-LOSS was trained by setting the loss function as the squared difference between the predicted time-to-arrival and the actual time-to-arrival. An activation function of softplus was applied. Predictions of SQ-LOSS were then compared to the testing period length of γ. If by the end of the training period, SQ-LOSS predicts the next time- to-arrival as s, then the prediction metric is γ-s. For time periods where no actual time-to-arrival was observed (i.e. no further purchases were observed by end of training), loss was set to 0.

For each customer, at each time period, the Recency, Frequency and Monetary (RFM) metrics were determined, which are commonly used in demand modeling, at 3 different levels; namely for all products, in-basket products and each individual product. Recency is the time since last purchase, Frequency is the number of repeat purchases and Monetary is the amount of money spent on all purchases to date. Included in the covariates are time-since-event (tse(t)) and indicators for whether a first purchase has occurred (pch(t)). The time-to-event (tse(t)) and the censoring status of the next arrival (unc(t)) were also determined.

On a per-product level, the types of covariates were limited to only RFM metrics (3 covariates) and transformations of purchase history (2 series). RFM metrics on the category and overall purchase history levels were available as well, but these account for an additional 6 covariates that were shared across the various purchase arrival processes. The total number of covariates for each product is thus 11, 6 of which are shared with other products.

Five baskets of popular replenishable products were selected for the example experiments. These were selected from products ranked by a score, where N_{unique} is the number of unique customers and X is the average purchases per customer:

score=X*log N_{unique} (11)

The five selected baskets were bars, deli, floss, pads, soda. Their data summaries are presented in TABLE 3, where μₒᵥₑᵣₐₗₗ is the average in-basket purchase counts, μₚₑᵣ₋ₛₖᵤ is the mean over the per-product average purchase counts, and pₒₜₕₑᵣₛ is the mean over the per-product proportion of buyers who bought another product in-basket. Also note that pₜᵣᵢₐₗ is the mean over the per-product proportion of trial customers (i.e. those who have made only a single purchase).

TABLE 3

| | | customers | | | | |
|---|---|---|---|---|---|---|
| basket | SKUs | (×1000) | μₒᵥₑᵣₐₗₗ | μₚₑᵣ₋ₛₖᵤ | pₒₜₕₑᵣₛ | pₜᵣᵢₐₗ |
| bars | 6 | 44 | 4.78 | 0.79 | 0.71 | 0.43 |
| deli | 12 | 79 | 3.58 | 0.29 | 0.55 | 0.62 |
| floss | 11 | 200 | 2.58 | 0.23 | 0.40 | 0.64 |
| pads | 7 | 317 | 2.26 | .032 | 0.28 | 0.66 |
| soda | 8 | 341 | 2.97 | 0.37 | 0.45 | 0.63 |

As shown, pads had the highest proportion of trial customers along with the smallest proportion of customers who bought another item in the basket. On the other hand, μₚₑᵣ₋ₛₖᵤ was roughly median in the baskets considered. This is similar for floss as well. For these categories, it would be reasonable to expect product purchases are strongly dependent. A good joint-prediction model should separate trial purchasers from repeat purchasers who decided to stick to one product after trying another.

Performance was measured based on the ROC-AUC metric where each of the models predicted whether customers who made in-basket purchases would make another in-basket purchase in a 4 week period after the end of a training period of 78 weeks. The RNN-based models had W=36 and predict arrival times jointly over different products for each customer. The RNG-F model was trained with 100 trees with covariates at week 74 and purchases between week 74 and 78 but predicts purchases for only one product at a time. As such, a separate RNG-F model is trained for each product.

The example experiments determined how each model does for every product in the basket, and as such, there are multiple ROC-AUC metrics. TABLE 4 shows the results of the example experiments in terms of summary statistics for ROC-AUCs for each item in the basket. The results illustrate that the MAT-RNN model of the present embodiments almost always dominates in the ROC-AUC metric for every category other than bars and deli, which has the smallest number of customers. Even so, MAT-RNN still performs the best in terms of average ROC-AUC among products in each category other than bars.

The number of products for which ROC-AUC has improved over RNG-F is substantial for the MAT-RNN model. Excluding bars where only 2 out of 6 products saw improved performance, other categories saw ROC-AUC improvements in more than 60% of the products in-category, with soda and pads showing improvements in all products. Advantageously, the ability to model sequential data and sequential dependence separates MAT-RNN model from RNG-F. Even though RNG-F is trained on the evaluation metric, it was determined that MAT-RNN almost always performed better in this binary classification task.

Notably, the performance difference of the MAT-RNN model of the present embodiments over SQ-LOSS and RNG-F is greatest for the pads category. This is likely due to the large amount of missing data since customers are least likely to buy other products. It was also determined that SQ-LOSS performs poorly compared to MAT-RNN, even though these models have a similar recurrent structure and are fed the same sequential data. One possible explanation is that the lack of ground truth data has a significant impact on the ability of SQ-LOSS to learn. In cases where event arrivals are sparse or where inter-purchase periods are long, the censored nature of the data gives no ground truth to train SQ-LOSS on. Therefore, even though the recurrent structure makes it possible to model sequential dependence, the structure that the MAT-RNN model imposes on the problem makes it much easier to make predictions with censored observations. Additionally, from the results, it was determined that the MAT-RNN model performs even better for larger customers with larger sample sizes.

TABLE 4

| | Customers | | | # Improved | ROC-AUC Quantiles | | | | | ROC-AUC |
|---|---|---|---|---|---|---|---|---|---|---|
| Category | (×1000) | Product | Model | over RNG-F | Min | Q25 | Q50 | Q75 | Max | Average |
| bars | 44 | 6 | RNG-F | — | 0.7696 | 0.7986 | 0.8428 | 0.8648 | 0.8710 | 0.8304 |
| | | | SQ-LOSS | 0 | 0.6608 | 0.7165 | 0.7228 | 0.7406 | 0.7550 | 0.7204 |
| | | | MAT-RNN | 2 | 0.7588 | 0.7762 | 0.8174 | 0.8537 | 0.8783 | 0.8167 |
| deli | 79 | 12 | RNG-F | — | 0.7452 | 0.7995 | 0.8389 | 0.9004 | 0.9220 | 0.8468 |
| | | | SQ-LOSS | 4 | 0.7763 | 0.8047 | 0.8248 | 0.8458 | 0.8810 | 0.8259 |
| | | | MAT-RNN | 8 | 0.8686 | 0.8823 | 0.8911 | 0.9021 | 0.9131 | 0.8919 |
| floss | 200 | 11 | RNG-F | — | 0.5537 | 0.6066 | 0.6199 | 0.6517 | 0.7683 | 0.6408 |
| | | | SQ-LOSS | 10 | 0.7298 | 0.7809 | 0.8089 | 0.8366 | 0.8739 | 0.8055 |
| | | | MAT-RNN | 11 | 0.8680 | 0.9016 | 0.9317 | 0.9421 | 0.9640 | 0.9214 |
| pads | 317 | 7 | RNG-F | — | 0.5851 | 0.6148 | 0.6358 | 0.6411 | 0.8234 | 0.6509 |
| | | | SQ-LOSS | 4 | 0.5650 | 0.6149 | 0.6392 | 0.6941 | 0.7154 | 0.6482 |
| | | | MAT-RNN | 7 | 0.8544 | 0.9160 | 0.9459 | 0.9511 | 0.9621 | 0.9281 |
| soda | 341 | 8 | RNG-F | — | 0.6959 | 0.7372 | 0.7663 | 0.7903 | 0.8300 | 0.7641 |
| | | | SQ-LOSS | 1 | 0.6844 | 0.7221 | 0.7259 | 0.7320 | 0.7612 | 0.7258 |
| | | | MAT-RNN | 8 | 0.8605 | 0.8669 | 0.8795 | 0.8854 | 0.8909 | 0.8768 |

From the example experiments, joint predictions enjoy some advantages over individual predictions as product purchases can be modeled better through joint modeling. Generally, if network structure is the same, then the amount of time required to train a separate model for each product scales linearly with the number of products. The number of parameters in a collection of individual models is also significantly larger than that of a joint model.

The advantages of training a joint MAT-RNN model over a collection of individual ones can be illustrated by comparing ROC-AUC performance in the soda basket, as shown in TABLE 5. The per-product individual models were given the same covariates but trained only on the purchase arrivals of that particular product. The network structure is the same with W=36, but the final densely connected layer outputs only a vector of size 2, since distributional parameters for one product is required. However, since the collection of single models have different weights for their RNNs, they have approximately 8 times the number of parameters found in the joint model. As shown in TABLE 5, there is a consistent advantage of a joint model over the individually trained single models, with improvements ranging from 0.0029 to 0.1098. Potential improvements in model performance can be observed by modeling purchase arrivals jointly, even with much fewer number parameters in the joint model.

TABLE 5

| sku | single | joint | diff |
|---|---|---|---|
| 1 | 0.8868 | 0.8897 | +0.0029 |
| 2 | 0.8073 | 0.8686 | +0.0614 |
| 3 | 0.8331 | 0.8605 | +0.0274 |
| 4 | 0.8501 | 0.8761 | +0.0260 |
| 5 | 0.8445 | 0.8829 | +0.0384 |
| 6 | 0.8193 | 0.8615 | +0.0422 |
| 7 | 0.8640 | 0.8909 | +0.0269 |
| 8 | 0.7742 | 0.8840 | +0.1098 |

Advantageously, the present embodiments can use a survival analysis approach with recurrent neural nets (RNN) to forecast joint arrival times until a next event for each individual over multiple items. The present inventors advantageously recognized the technical advantages of transforming an arrival time problem into a likelihood-maximization problem with loose distributional assumptions regarding inter-arrival times. The example experiments demonstrated that not only can known parameters be recovered during fitting, but also that there are substantial improvements over other approaches.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for individual forecasting of a future event for a subject using historical data, the historical data comprising a plurality of historical events associated with the subject, the method executed on at least one processing unit, the method comprising:
receiving the historical data associated with the subject;
determining a random variable representing a remaining time until the future event;
predicting a time to the future event using a distribution function that is determined using a recurrent neural network, the distribution function comprising a learned density with peaks that approximate the times of the historical events in the historical data;
determining a log-likelihood function based on a probability that the random variable exceeds an amount of time remaining until a next historical event in the historical data and parameterized by the distribution function; and
outputting a forecast of a time to the future event as the log-likelihood function.

2. The method of claim 1, wherein a loss function for the recurrent neural network comprises a negative of the log-likelihood function.

3. The method of claim 1, wherein the random variable is conditioned based on inter-arrival times of the historical events in the historical data.

4. The method of claim 1, wherein the random variable is conditioned based on excess times since arrival of preceding historical events in the historical data.

5. The method of claim 1, wherein the log-likelihood function at each time is the log of the probability that the random variable is in the set of time until the next historical event when the next historical event has been observed, and the log of the survival function otherwise.

6. The method of claim 5, wherein the distribution function follows a Weibull distribution.

7. The method of claim 6, wherein the distribution function is determined as (k/λ)((s+t)/λ)^{k-1}S_{W}(t), where k is the shape of the Weibull distribution, λ is the scale of the Weibull distribution, t is the time-step, and S_{W}(t) is the survival function.

8. The method of claim 1, wherein outputting the forecast of the time to the future event as the log-likelihood function comprises determining a sum of log-likelihoods at each time-step.

9. The method of claim 8, further comprising transforming the sum of log-likelihoods as a function of recurrent neural network parameters and historical data, and determining a minimizer of an overall observed loss of the recurrent neural network using such function.

10. The method of claim 1, further comprising outputting derivative values of the log-likelihood function.

11. A system for individual forecasting of a future event for a subject using historical data, the historical data comprising a plurality of historical events associated with the subject, the system comprising one or more processors in communication with a data storage, the one or more processors configurable to execute:
a data acquisition module to receive the historical data associated with the subject;
a conditional excess module to determine a random variable representing a remaining time until the future event;
a machine learning module 120 to predict a time to the future event using a distribution function that is determined using a recurrent neural network, the distribution function comprising a learned density with peaks that approximate the times of the historical events in the historical data; and
a forecasting module to determine a log-likelihood function based on a probability that the random variable exceeds an amount of time remaining until a next historical event in the historical data and parameterized by the distribution function, and to output a forecast of a time to the future event as the log-likelihood function.

12. The system of claim 11, wherein a loss function for the recurrent neural network comprises a negative of the log-likelihood function.

13. The system of claim 11, wherein the random variable is conditioned based on inter-arrival times of the historical events in the historical data.

14. The system of claim 11, wherein the random variable is conditioned based on excess times since arrival of preceding historical events in the historical data.

15. The system of claim 11, wherein the log-likelihood function at each time is the log of the probability that the random variable is in the set of time until the next historical event when the next historical event has been observed, and the log of the survival function otherwise.

16. The system of claim 15, wherein the distribution function follows a Weibull distribution.

17. The system of claim 16, wherein the distribution function is determined as (k/λ)((s+t)/λ)^{k-1} S_{W}(t), where k is the shape of the Weibull distribution, λ is the scale of the Weibull distribution, t is the time-step, and S_{W}(t) is the survival function.

18. The system of claim 11, wherein outputting the forecast of the time to the future event as the log-likelihood function comprises determining a sum of log-likelihoods at each time-step.

19. The system of claim 18, wherein the forecasting module further transforms the sum of log-likelihoods as a function of recurrent neural network parameters and historical data, and determining a minimizer of an overall observed loss of the recurrent neural network using such function.

20. The system of claim 11, wherein the forecasting module further outputs derivative values of the log-likelihood function.
